(19) United States
(12) Patent Application Publication
(10) Pub. No.: US 2026/0336690 A1
(43) Pub. Date: Oct. 29, 2026

(54) REDUNDANT STEERING SYSTEM FAULT MODE AND FUZZY TRANSITION TO BACKUP OPERATION

(71) Applicant: Steering Solutions IP Holding Corporation, Saginaw, MI (US)

(72) Inventors: Michal Lewecki, Zabrze (PL); Mateusz J. Ostafin, Rogoznik (PL)

(21) Appl. No.: 19/256,572

(22) Filed: Jul. 1, 2025

(30) Foreign Application Priority Data
Apr. 24, 2025 (PL) P.451865

(51) Int. Cl. B62D 5/04

(52) U.S. Cl. CPC B62D 5/0484; B62D 5/0487; B62D 5/0493

(57) ABSTRACT

A method for transitioning control of a vehicle component from a primary controller to a dependent controller includes, using one or more processors, detecting fault occurrences associated with a first control signal generated using the primary controller, determining a fault energy associated with the detected fault occurrences and obtaining an error energy accumulation signal based on the fault energy, generating a second control signal using the dependent controller, and controlling the vehicle component based on the first control signal, the second control signal, and the error energy accumulation signal.

### CROSS-REFERENCE TO RELATED APPLICATIONS

This application claims the benefit of Patent Application No. P.451865 filed in Poland on Apr. 24, 2025. The entire disclosure of the application referenced above is incorporated herein by reference.

### TECHNICAL FIELD

This disclosure relates to operation of and transition to backup controllers (e.g., backup or redundant ECUs) for vehicle systems.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

### SUMMARY OF THE INVENTION

This disclosure relates generally to operation of and transition to backup controllers (e.g., backup or redundant ECUs) for vehicle systems.

A method for transitioning control of a vehicle component from a primary controller to a dependent controller includes, using one or more processors, detecting fault occurrences associated with a first control signal generated using the primary controller, determining a fault energy associated with the detected fault occurrences and obtaining an error energy accumulation signal based on the fault energy, generating a second control signal using the dependent controller, and controlling the vehicle component based on the first control signal, the second control signal, and the error energy accumulation signal.

In another aspect, a system is configured to perform one or more functions of the various methods described herein. In another aspect, a processor is configured to execute instructions stored in memory to perform one or more functions of the various methods described herein.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 1C generally illustrates an example of binary fault detection and accumulation.

FIG. 2A shows an example system configured to control an actuator using redundant controllers or ECUs according to the principles of the present disclosure.

FIG. 2B illustrates an example transition between primary and dependent controllers according to the principles of the present disclosure.

FIGS. 2C and 2D illustrate example debounce counters according to the principles of the present disclosure.

FIG. 2E illustrates an example classification of “no fault,” “low fault,” “high fault,” and “fault” zones or states according to the principles of the present disclosure.

FIG. 2F illustrates an example system configured to transition between a control signal generated by a primary controller and a control signal generated by a dependent controller according to the principles of the present disclosure.

FIG. 2G illustrates an example implementation of a combined signal calculation algorithm or process according to the principles of the present disclosure.

FIG. 3 is a flow diagram generally illustrating steps of a method for transitioning control from a primary controller to a dependent controller according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

A vehicle system, such as a steering system, may include various controller architectures to control various actuators for engaging and/or actuating other components of the steering system. Some example systems include one or more domain controllers. Each domain controller may be configured to control functions of a specific area or domain of the vehicle. For example, a steering domain controller may be configured to control functions of the steering system, including controlling the various actuators.

An example steering system may include multiple types of controllers (e.g., in addition to or instead of domain controllers), microcontrollers, etc. (e.g., electronic control units, or ECUs) to provide redundancy for communication and control signals within the steering system. In some examples, two or more controllers may be arranged in a primary-dependent configuration wherein a first controller is configured to function as a primary controller and a second controller is configured to function as a backup/redundant (e.g., dependent or secondary) controller. Signals are transmitted between the primary and dependent controllers (e.g., a transmission side and a reception side, respectively) via a communication interface. In some examples, the communication interface implements Inter Micro Communication (IMC) using a Universal Asynchronous Receiver/Transmitter (UART) protocol.

In such a configuration, control transitions from the primary controller to the dependent controller in response to a failure/loss of operation of the primary controller. However, when the primary controller fails, there is typically a delay or transition time associated with transitioning control to the dependent controller (e.g., ~30 ms or more). During this transition time, control of a corresponding system component, actuator, etc. may be degraded (e.g., due to asynchronous processing of the ECUs).

Transition control systems and methods according to the principles of the present disclosure are configured to decrease transition time during transition of control from the primary controller to the dependent controller, and to reduce degradation of control during the transition time. These systems and methods may implement fuzzy control transition techniques to incrementally decrease control of the primary controller while increasing control of the dependent controller as one or more faults accumulate (e.g., as indicators/flags for detected faults increase). In one example, respective weights applied to outputs/control signals of the primary and dependent controllers gradually decrease and increase, respectively, during transition of control as described below in more detail. Control may transition from complete (e.g., 100%) control of the primary controller to a “blended” control mode using both the primary and dependent controllers, and from the blended control mode to a complete control of the dependent controller.

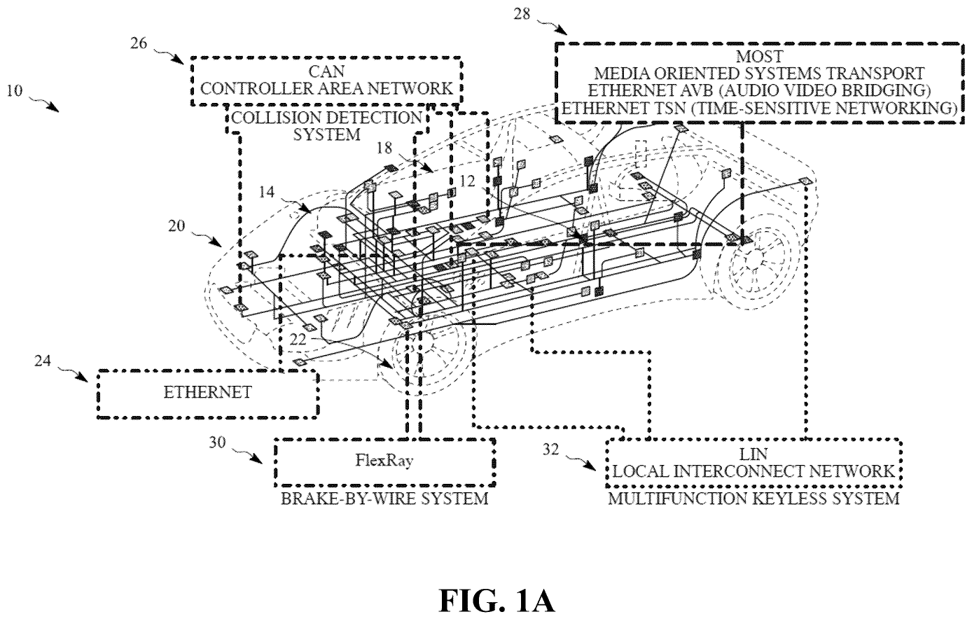

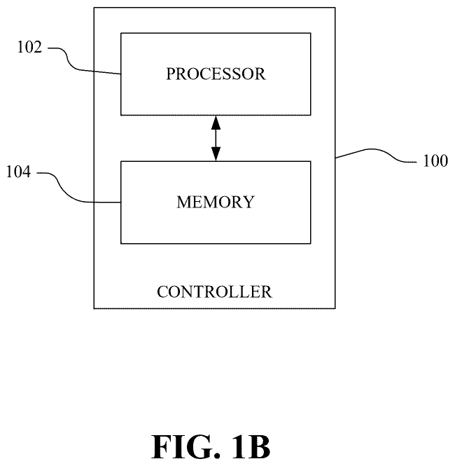

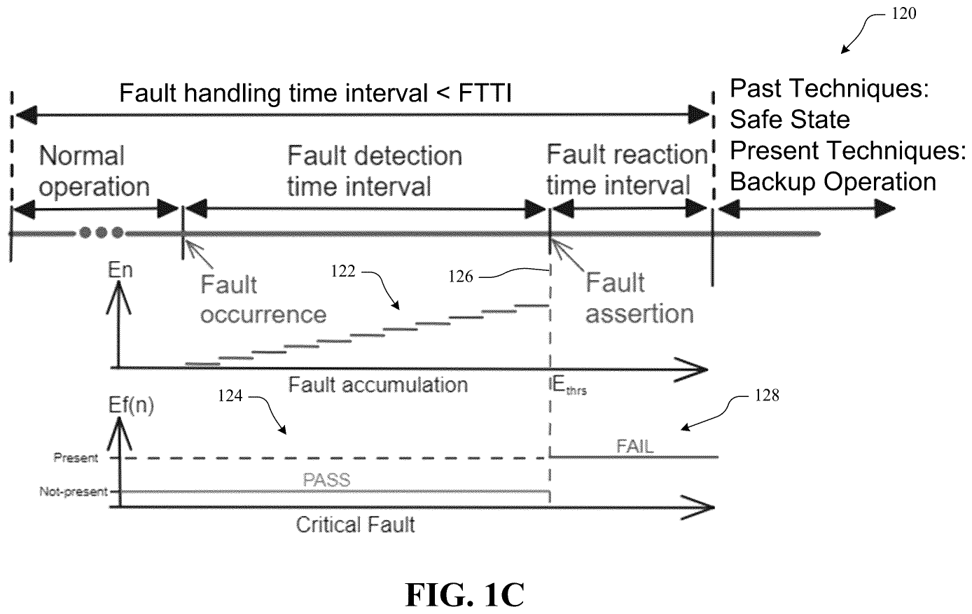

FIG. 1A generally illustrates a vehicle 10 according to the principles of the present disclosure. The vehicle 10 may include any suitable vehicle, such as a car, a truck, a sport utility vehicle, a minivan, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

In some embodiments, the vehicle 10 includes one or more controllers, such as controller 100, as is generally illustrated in FIG. 1B. The controller 100 may correspond to a steering system controller. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof.

As used herein, “controller” may refer to a hardware module or assembly including one or more processors or microcontrollers, memory, sensors, one or more actuators, a communication interface, etc., any portions of which may be collectively referred to as “circuitry.” As described herein, respective functions and steps performed by a given controller, control circuitry, etc. may be collectively performed by multiple controllers, processors, etc. For example, a processor, processing device, controller, control circuitry, etc. “configured to perform” may refer to a single processor, processing device, controller, etc. configured to perform both A and B or may refer to a first processor, processing device, controller, etc. configured to perform A and a second processor, processing device, controller, etc. configured to perform B. For simplicity, “control circuitry configured to perform A and B” may refer to a single or multiple processors, processing devices, controllers, etc. collectively configured to perform A and B.

In some embodiments, the controller 100 may perform the methods described herein. However, the methods described herein as performed by the controller 100 are not meant to be limiting, and any type of software executed on a controller, processor, or other circuitry can implement the hysteresis shaping techniques described herein without departing from the scope of this disclosure. For example, a controller, such as a processor executing software within a computing device, can implement the systems and methods described herein.

In some conventional example systems, faults are detected/accumulated in a binary (e.g., fault present or fault not present) manner. For example, a detection of a fault instance (e.g., a measurement or signal value above/below a threshold, signal degradation or interruption, etc.) may cause a fault count/counter to increment, increase a calculation of fault energy, etc. Control may transition from the primary controller to the dependent controller in response to the fault count/energy (“fault accumulation”) reaching or exceeding a threshold. Prior to the fault accumulation reaching the threshold, control remains with the primary controller. Accordingly, control transition time includes both an amount of time required for the fault accumulation to reach the threshold and an amount of time required to transition control from the primary controller to the dependent controller (e.g., including signal exchanges between the primary and dependent controllers, state transitions, asynchronous operation, etc.).

An example of binary fault detection and accumulation is shown at 120 of FIG. 1C. For example, during normal operation of a primary controller, a fault occurrence may be detected. However, rather than immediately transitioning to control of the dependent controller (e.g., in case the fault occurrence resulted from a measurement anomaly or other temporary condition), the fault begins to accumulate in a fault detection time interval as shown at 122. For example, an energy (a fault energy) associated with the fault begins to increase (e.g., as additional fault occurrences are detected). As one example, fault energy E_{f} can be calculated in accordance with

$${E}_{f} = {\int }_{0}^{T} e ( t ) dt \approx {E}_{f ( n )} = {\sum }_{0}^{N} {e}_{n} .$$

A fault is not asserted (i.e., asserted to cause transition of control to the dependent controller) until fault accumulation reaches/exceeds a threshold (e.g., until fault energy reaches/exceeds a fault energy threshold). Accordingly, prior to reaching the threshold, the primary controller is considered to be in a “pass” state as shown at 124 (i.e., a fault is “not present”). Conversely, when fault accumulation reaches the threshold at a time indicated at 126, the fault is asserted and the primary controller is considered to be in a “fail” state as shown at 128 (i.e., a fault is “present”). In other words, fault assertion and transition function in a “binary” manner. Asserting the fault causes control to transition from the primary controller to the dependent controller over a fault reaction time interval. Accordingly, a total transition time (and corresponding period of degraded or interrupted control) may include both the fault detection time interval and the fault reaction time interval prior to backup operation being implemented.

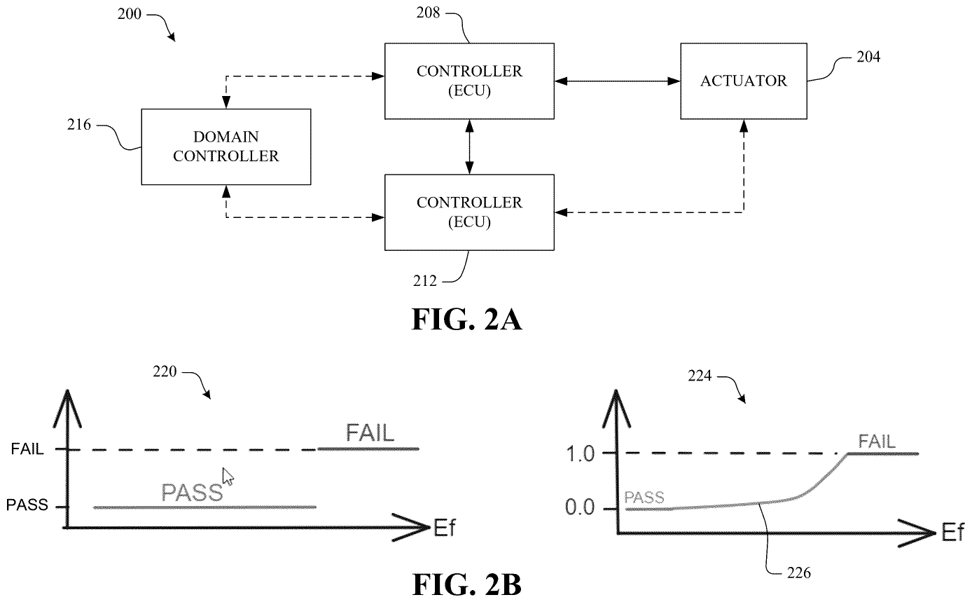

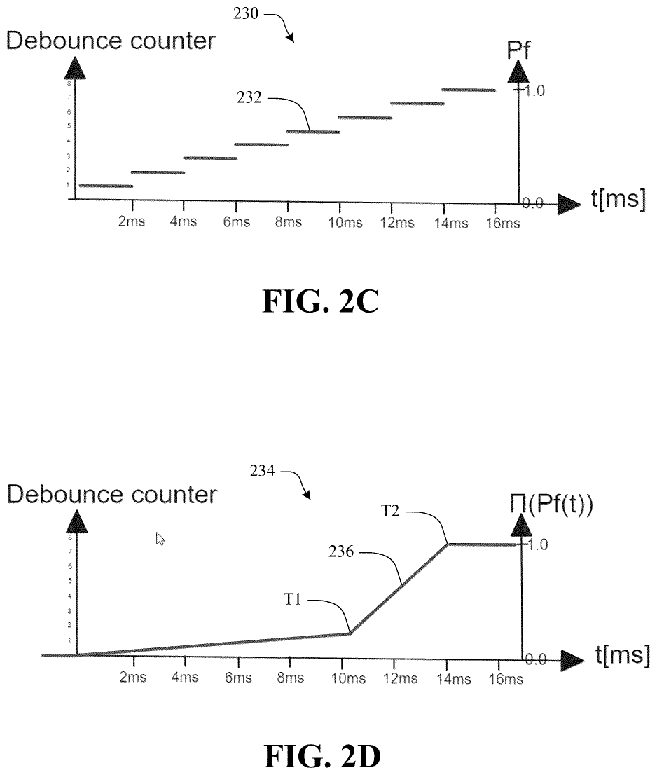

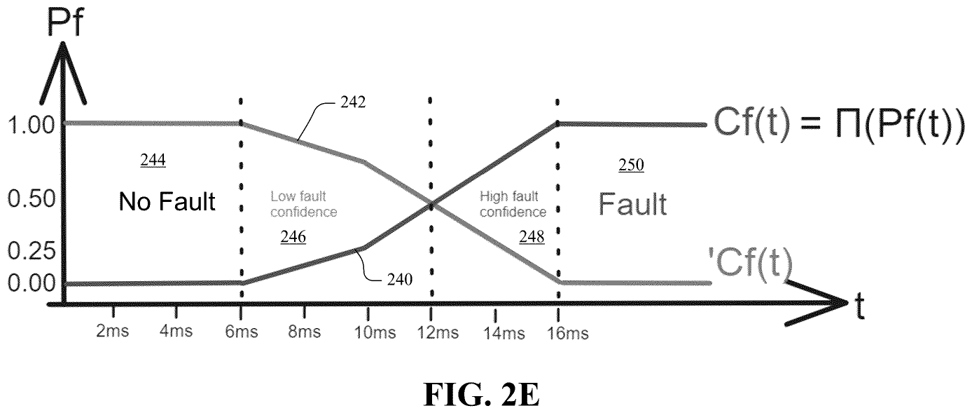

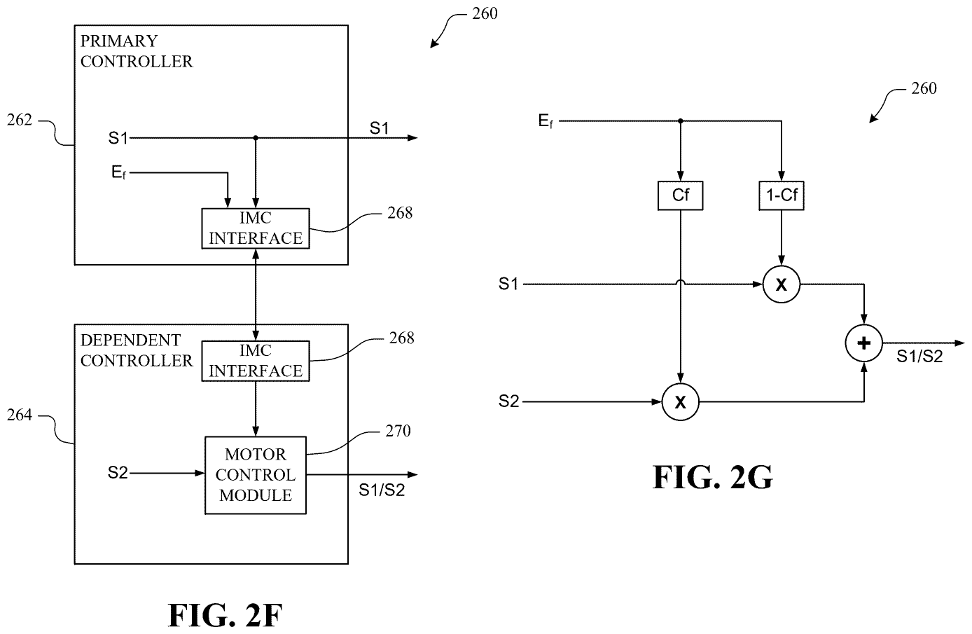

FIG. 2A shows an example system 200 (e.g., a steering control system) configured to control an actuator 204 (e.g., an actuator of a steering system, such as an SbW steering system) using redundant controllers or ECUs (e.g., controllers 208 and 212) in a primary-dependent configuration in accordance with the principles of the present disclosure. For example, the controller 208 may correspond to a primary controller and the controller 212 may correspond to a dependent controller. In some examples, one or both of the controllers 208, 212 may be configured to, individually or collectively, implement systems and methods configured to perform fuzzy control transition techniques according to the principles of the present disclosure. In other examples, a separate controller (e.g., a domain controller 216) may be configured to perform all or portions of the systems and methods of the present disclosure. The actuator 204 is shown as only one example component or type of component responsive to control of redundant controllers in accordance with the principles of the present disclosure.

FIG. 2B illustrates an example transition between primary and dependent controllers according to the present disclosure. For example, binary transition control (i.e., where a fault is either not asserted/not present or asserted/present) from a pass state to a fail state is shown at 220. Conversely, example “fuzzy” (e.g., gradual, incremental, etc.) transition control from a pass state to a fail state according to the present disclosure is shown at 224. As an example, rather than simply assigning a pass (e.g., 0) or fail (e.g., 2) value to pass/fail signal or output 226, the pass/fail signal 226 can be assigned a plurality of intermediate (continuous or discrete states) values between 0 and 1. As one example, the pass/fail signal 226 may be calculated/based on a probability of fault assertion (e.g., based on a probability of a calculated fault energy indicating the presence of a fault). In other words, as fault accumulation increases, the probability of the presence of a fault increases. Accordingly, transition of control from the primary controller to the dependent controller can be initiated at some intermediate time subsequent to a first detection of a fault and prior to fault energy/count reaching a threshold. For example, transition of control from the primary controller to the dependent controller can be performed in response to the probability reaching/exceeding a probability threshold.

In an example, systems and methods according to the present disclosure may implement a debounce counter as shown in FIGS. 2C and 2D. As shown in FIG. 2C, a debounce counter 230 indicates a probability 232 (Pf) that a fault will be asserted. The probability 232 increases toward a fault probability Pf of 1.0 as fault occurrences (e.g., consecutive fault occurrences) are detected within a given time period. For example, to reach the Pf of 1.0, a predetermined number of fault occurrences may be detected within a time period. In situations where a fault occurrence rate decreases or stops (e.g., fault occurrence are no longer detected and faults do not accumulate), Pf may never reach 1.0 and may decrease and a fault is not ultimately asserted.

The probability of occurrence of a fault Pf corresponds to an amount of fault energy accumulated. As one example, an overall fault energy E_{f} (e.g., corresponding to an error energy accumulation signal) can be calculated according to

$${E}_{f} = {\sum }_{0}^{N} {e}_{n} ,$$

where eₙ corresponds to an energy associated with a single fault occurrence. The fault probability Pf can be calculated according to

$${P}_{f} = \frac{1}{N} {\sum }_{0}^{N} {e}_{n} ,$$

where Λ_{n∈[0,N]}eₙ=1. Accordingly,

$${P}_{f} = \frac{n}{N} for n ∈ [ 0 , N ] and {P}_{f} = min [ ( \frac{t - {t}_{0}}{{t}_{s}} ) , 1 ] ,$$

where tₛ is a sampling time (e.g.,2 ms), t is time, and t₀ is a time of a first fault occurrence. Accordingly, as faults are accumulated (as represented by the debounce counter in FIG. 2C), an error energy accumulation signal can be calculated as described above. The error energy accumulation signal can be used to shift control responsibly (e.g., from the controller 208 to the controller 212), allowing faster reaction to fault occurrences.

However, in some examples, when Pf reaches some intermediate value less than 1.0 (i.e., as accumulated fault energy increases), a probability that Pf will ultimately reach 1.0 increases significantly. For example, as shown in FIG. 2D, a debounce counter 234 according to the present disclosure indicates a weighted probability 236 (ΠPf) that a fault will be asserted. Rather than requiring ΠPf to reach 1.0, a transition of control can be initiated when ΠPf reaches/exceeds some intermediate value between 0.0 and 1.0. For example, as shown, ΠPf begins to increase at a greater rate at a point/time t1. Accordingly, a transition of control can be initiated at a time between the point/time T1 and a point/time T2 (e.g., in response to ΠPf reaching a predetermined value, such as 0.2., 0.3, 0.5, etc.).

FIG. 2E illustrates an example classification of “no fault,” “low fault,” “high fault,” and “fault” zones or states. For example, a probability of “fault” membership (e.g., where Cf(t) is a membership function corresponding to a weighted fault probability ΠPf) is shown at 240 while a probability of “no fault” membership (e.g., ‘Cf(t)) is shown at 242. For example, ‘Cf(t) decreases as Cf(t) increases (e.g., ‘Cf(t)=1−Cf(t)). In other words, fault confidence/probability is low when “no fault” confidence/probability is high and fault confidence/probability is high when “no fault” confidence/probability is low. As shown, a relationship between “fault” and “no fault” confidence may define a “no fault” zone/state 244, a “low fault” (i.e., a low fault confidence/probability) zone/state 246, a “high fault” (i.e., a high fault confidence/probability) zone/state 248, and a “fault” zone/state 250.

In an example system including a primary controller and a dependent controller according to the present disclosure, a controlled and continuous transition from the primary controller to the dependent controller (e.g., from control using a control signal/output S1 of the primary controller to a control signal/output S2 of the dependent controller) can be implemented based on detection of fault occurrences and increased probability of fault assertion (e.g., increased confidence/probability of membership of the primary controller to a “high fault confidence” or “fault” state, such as indicated by a membership function). For example, as fault energy accumulated by the primary controller increases, control is transitioned/shifted over time to the dependent controller. Once a “full” fault assertion point is reached (e.g., fault probability is 1.0, the fault is asserted, etc.), control has already been completely transitioned from the primary controller to the dependent controller.

FIG. 2F illustrates an example system 260 configured to transition between a control signal/output S1 generated by a primary controller 262 and a control signal/output S2 generated by a dependent controller 264. For example, during normal operation (i.e., operation without detected fault occurrences), the primary controller 262 generates and outputs the control signal S1 to control one or more system components, actuators, motors, etc. As one example, the control signal S1 corresponds to a motor control or torque signal.

The primary controller 262 obtains a value/signal indicative of fault occurrences/detected faults, such as a fault energy Er signal as described herein. In some examples, the primary controller 262 calculates the fault energy. In other examples, another controller or component calculates the fault energy and the primary controller 262 receives the fault energy signal. The primary controller 262 provides the fault energy signal and the control signal S1 to the dependent controller 264. For example, the primary controller 262 and the dependent controller 264 communicate via respective IMC interfaces 268.

The dependent controller 264 is configured to generate a control signal S2. The control signal S2 is configured to control the same system component as the control signal S1. For example, the control signal S2 is a redundant control signal with respect to the control signal S1. The dependent controller 264 is further configured to generate a combined/blended control signal S1/S2 (a transition signal S1/S2) based on the control signals S1 and S2 and the fault energy signal Er as described herein. As one example, a motor control module 270 is configured to generate the combined control signal S1/S2 based on the control signals S1 and S2 and the fault energy signal. Although shown as being included within the dependent controller 264, the motor control module 270 may be implemented external to the dependent controller 264, such as within another controller/control circuitry, a domain controller, etc.

For example, during normal operation, the control signal S1 output by the primary controller 262 is used to control the system component. When a fault occurrence is detected (e.g., a fault associated with the primary controller 262, the control signal S1, etc.), control may begin to transition to the dependent controller 264 and the combined control signal S1/S2 as described herein (e.g., by adjusting respective weights applied to the signals S1 and S2). For example, during normal operation (and upon initial detection of a fault occurrence associated with the control signal S1), the signal S1 may assigned a weight of 1.0 (or 100%) while the signal S2 may be assigned a weight of 0.0 (or 0%). Accordingly, the combined signal S1/S2 is simply the same as the control signal S1. However, as fault occurrences and energy increase, the weight assigned to the control signal S1 decreases while the weight assigned to the control signal S2 increases. Ultimately, the fault is asserted when fault occurrences/energy reach a threshold (e.g., a threshold corresponding to 100% fault probability), the control signal S1 is assigned a weight of 0%, and the control signal S2 is assigned a weight of 100%.

FIG. 2G illustrates an example implementation of a combined signal calculation algorithm or process 280 (e.g., implemented by the motor control module 270). For example, the algorithm receives, as inputs, the control signals S1 and S2 and the fault energy signal/value E_{f}. The control signal S2 is weighted in accordance with Cf, which is a function of E_{f} as described above. Conversely, the control signal S1 is weighted in accordance with 1-Cf. Accordingly, the combined signal may be a sum of the weighted control signal S1 and the weighted control signal S2. In this manner, as E_{f} increases, the probability of fault assertion and Cf increase while the probability of no fault assertion and 1-Cf decrease.

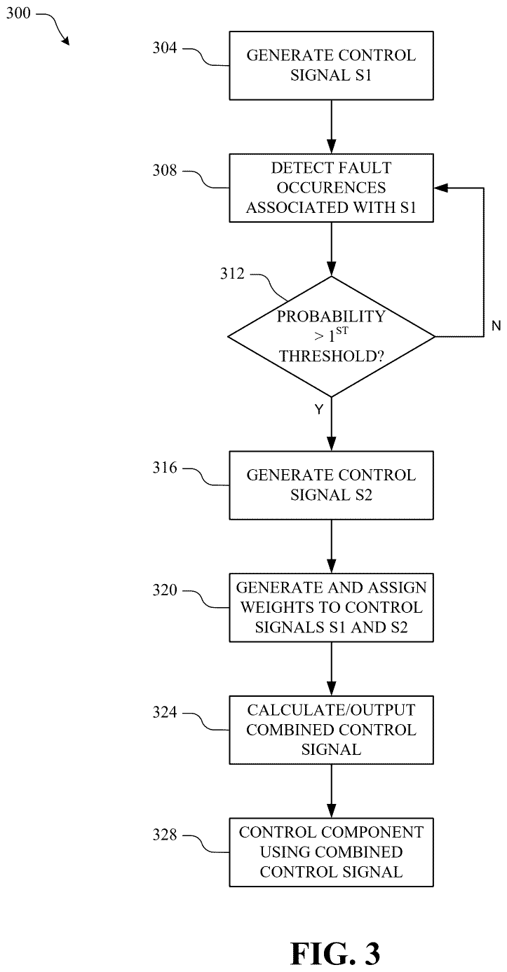

FIG. 3 is a flow diagram generally illustrating a method 300 for transitioning control from a primary controller to a dependent controller according to the principles of the present disclosure. For example, one or more computing devices, processors, or processing devices, etc. are configured to execute instructions to implement the method 300, such as one or more of the processors of the systems described herein (e.g., a computing device or processor of a vehicle configured to implement the controller 100, the system 200, etc.). One or more of the steps of the method 300 as described below may be skipped or omitted in some examples, and/or one or more of the steps may be performed in a different sequence than described.

At 304, the method 300 includes generating, using a primary controller, a control signal (e.g., a control signal S1) to control a component of a system of a vehicle, such as a motor or actuator of a steering system of the vehicle.

At 308, the method 300 includes detecting one or more fault occurrences associated with the control signal S1. At 312, the method 300 includes determining whether a fault count or energy or a fault assertion probability associated with the detected fault occurrences is greater than a first threshold. For example, at 312, the method 300 includes determining whether a fault assertion probability associated with the fault count or energy is greater than a first probability threshold. If true, the method 300 continues to 316. If false, the method 300 continues to 308.

At 316, the method 300 includes generating, using a dependent controller, a control signal S2 to control the component of the system of the vehicle. In other words, the control signal S2 corresponds to a redundant control signal with respect to the control signal S1.

At 320, the method 300 includes generating and assigning weights to the control signals S1 and S2. For example, the weights are assigned and generated based on the determined fault count or energy and associated fault assertion probability as described herein. At 324, the method 300 includes calculating and outputting a combined control signal using the weighted control signals S1 and S2. For example, the combined control signal may be calculated by summing the weighted control signals S1 and S2. As the fault assertion probability increases, the weight assigned to the control signal S1 decreases to 0.0 or 0% while the weight assigned to the control signal S2 increases to 1.0 or 100%. Accordingly, when the fault is ultimately asserted, the combined control signal is essentially equal to the control signal S2. At 328, the method 300 includes controlling the component using the combined control signal.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for transitioning control of a vehicle component from a primary controller to a dependent controller, the method comprising, using one or more processors:
detecting fault occurrences associated with a first control signal generated using the primary controller;
determining a fault energy associated with the detected fault occurrences and obtaining an error energy accumulation signal based on the fault energy;
generating a second control signal using the dependent controller; and
controlling the vehicle component based on the first control signal, the second control signal, and the error energy accumulation signal.

2. The method of claim 1, further comprising:
generating a combined control signal based on the first control signal, the second control signal, and the error energy accumulation signal.

3. The method of claim 1, further comprising:
calculating a fault assertion probability based on the fault energy; and
controlling the vehicle component further based on the fault assertion probability.

4. The method of claim 3, further comprising:
assigning a first weight to the first control signal based on the fault assertion probability to obtain a first weighted control signal;
assigning a second weight to the second control signal based on the fault assertion probability to obtain a second weighted control signal; and
controlling the vehicle component further based on the first weighted control signal and the second weighted control signal.

5. The method of claim 4, further comprising obtaining a sum of the first weighted control signal and the second weighted control signal.

6. The method of claim 3, further comprising controlling the vehicle component further based on a determination of whether the fault assertion probability exceeds a threshold.

7. The method of claim 1, wherein the vehicle component is a component of a steering system of the vehicle.

8. The method of claim 1, wherein the vehicle component is at least one of an actuator and a motor of a steering system of the vehicle.

9. The method of claim 1, wherein the primary controller and the dependent controller are electronic control units (ECUs) of the vehicle.

10. The method of claim 1, further comprising calculating a membership function indicating a probability of a fault occurrence.

11. The method of claim 10, further comprising transitioning control from the primary controller to the dependent controller based on the membership function.

12. A system for transitioning control of a vehicle component from a primary controller to a dependent controller, the system comprising:
a processor configured to execute instructions stored in memory, wherein executing the instructions causes the processor to
detect fault occurrences associated with a first control signal generated using the primary controller,
determine a fault energy associated with the detected fault occurrences and obtaining an error energy accumulation signal based on the fault energy,
generate a second control signal using the dependent controller, and
control the vehicle component based on the first control signal, the second control signal, and the error energy accumulation signal.

13. The system of claim 12, wherein executing the instructions further causes the processor to:
generate a combined control signal based on the first control signal, the second control signal, and the error energy accumulation signal.

14. The system of claim 12, wherein executing the instructions further causes the processor to:
calculate a fault assertion probability based on the fault energy; and
control the vehicle component further based on the fault assertion probability.

15. The system of claim 14, wherein executing the instructions further causes the processor to:
assign a first weight to the first control signal based on the fault assertion probability to obtain a first weighted control signal;
assign a second weight to the second control signal based on the fault assertion probability to obtain a second weighted control signal; and
control the vehicle component further based on the first weighted control signal and the second weighted control signal.

16. The system of claim 15, wherein executing the instructions further causes the processor to obtain a sum of the first weighted control signal and the second weighted control signal.

17. The system of claim 14, wherein executing the instructions further causes the processor to control the vehicle component further based on a determination of whether the fault assertion probability exceeds a threshold.

18. The system of claim 12, wherein the vehicle component is a component of a steering system of the vehicle.

19. The system of claim 12, wherein the vehicle component is at least one of an actuator and a motor of a steering system of the vehicle.

20. A system, comprising:
a primary controller configured to generate a first control signal to control a vehicle component;
a dependent controller configured to generate a second control signal to control the vehicle component, wherein the second control signal corresponds to a redundant control signal for the vehicle component; and
one or more processors configured to
detect fault occurrences associated with the first control signal generated using the primary controller,
determine a fault energy associated with the detected fault occurrences and obtain an error energy accumulation signal based on the fault energy, and
control the vehicle component based on the first control signal, the second control signal, and the error energy accumulation signal.
